(19) United States
(12) Patent Application Publication
(10) Pub. No.: US 2026/0274285 A1
(43) Pub. Date: Sep. 17, 2026

(54) DRIVING ASSISTANCE DEVICE, DRIVING ASSISTANCE METHOD, AND STORAGE MEDIUM

(71) Applicant: HONDA MOTOR CO., LTD., Minato-ku, Tokyo (JP)

(72) Inventors: Misako Yoshimura, Wako-shi (JP); Kosuke Nakanishi, Wako-shi (JP); Shigenobu Saigusa, Wako-shi (JP); Takaaki Beppu, Tokyo (JP); Haojie Wang, Tokyo (JP)

(21) Appl. No.: 19/469,587

(22) PCT Filed: Mar. 30, 2023
(86) PCT No.: PCT/JP2023/013227

§ 371 Date: Sep. 26, 2025

(51) Int. Cl. B60W 50/14; B60W 30/095; B60W 40/08; G06V 20/59; G06V 40/18

(52) U.S. Cl. CPC B60W 50/14; B60W 30/0956; B60W 40/08; G06V 20/597; G06V 40/18; B60W 2050/143; B60W 2050/146; B60W 2420/403; B60W 2540/225; B60W 2540/229; B60W 2554/80

(57) ABSTRACT

According to an embodiment, a driving assistance device includes a recognizer configured to recognize a surrounding situation of a vehicle, an estimator configured to estimate a sight line direction of a driver of the vehicle, and a determiner configured to determine whether or not the driver has visually recognized a traffic participant near the vehicle recognized by the recognizer on the basis of the sight line direction. The determiner determines that the driver has also visually recognized another traffic participant located within a predetermined distance from a traffic participant determined to have been visually recognized by the driver among the traffic participants.

### TECHNICAL FIELD

The present invention relates to a driving assistance device, a driving assistance method, and a program.

### BACKGROUND ART

In recent years, efforts to provide access to sustainable transportation systems have been increasingly active in consideration of vulnerable individuals among traffic participants. For this realization, research and development efforts are focused on further improving the safety and convenience of transportation through research and development related to driving assistance technology. In relation to this, conventionally, there are known technologies for safety confirmation alerts or controlling a driving state of a vehicle on the basis of a driver's visibility for a safety confirmation target object in accordance with a distance or an angle from the driver's sight line direction to a target object, determining whether or not the driver has recognized a target on the basis of a degree of overlap between a plurality of determination points in an area of the target and a visual field range, and receiving pedestrian information indicating whether or not a pedestrian belongs to a pedestrian group formed by a plurality of pedestrians from a pedestrian communication device and presenting pedestrian attention information (see, for example, Patent Documents 1 to 3).

### CITATION LIST

### Patent Document

Patent Document 1: PCT International Publication No. WO/2008/029802

Patent Document 2: Japanese Unexamined Patent Application, First Publication No. 2020-201670

Patent Document 3: PCT International Publication No. WO/ 2013/080249

### SUMMARY OF INVENTION

### Technical Problem

Incidentally, in driving assistance technology, when a plurality of traffic participants are located near a vehicle, there is a problem because there is a possibility that a processing load and a processing time may be incurred to individually determine whether or not the driver has visually recognized each traffic participant.

In order to solve the above problem, an objective of the present application is to provide a driving assistance device, a driving assistance method, and a program that can enable whether or not a driver has visually recognized a nearby traffic participant to be more efficiently determined. Also, the present invention contributes to the development of a sustainable transportation system.

### Solution to Problem

A driving assistance device, a driving assistance method, and a program according to the present invention adopt the following configurations.

(1) According to an aspect of the present invention, there is provided a driving assistance device including: a recognizer configured to recognize a surrounding situation of a vehicle; an estimator configured to estimate a sight line direction of a driver of the vehicle; and a determiner configured to determine whether or not the driver has visually recognized a traffic participant near the vehicle recognized by the recognizer on the basis of the sight line direction, wherein the determiner determines that the driver has also visually recognized another traffic participant located within a predetermined distance from a traffic participant determined to have been visually recognized by the driver among the traffic participants.

(2): In the above-described aspect (1), the predetermined distance is different between a direction extending in the sight line direction of the driver of the vehicle and a direction perpendicular to the sight line direction.

(3): In the above-described aspect (2), the predetermined distance becomes longer as a direction from a position of the traffic participant becomes closer to the extending direction and becomes shorter as the direction from the position of the traffic participant becomes closer to the perpendicular direction.

(4): In the above-described aspect (1), the estimator estimates a risk value of the traffic participant, and, when the other traffic participant is located within the predetermined distance, the determiner determines that the other traffic participant has not been visually recognized if a risk value of the other traffic participant estimated by the estimator is greater than or equal to a threshold value.

(5): In the above-described aspect (4), the estimator estimates the risk value in accordance with an amount of movement or an attribute of the traffic participant.

(6): In the above-described aspect (1), the driving assistance device further include a notification unit configured to provide a notification to the driver when there are traffic participants not recognized by the driver.

(7) According to an aspect of the present invention, there is provided a driving assistance method including: recognizing, by a computer, a surrounding situation of a vehicle; estimating, by the computer, a sight line direction of a driver of the vehicle; determining, by the computer, whether or not the driver has visually recognized a traffic participant near the vehicle recognized on the basis of the sight line direction; and determining, by the computer, that the driver has also visually recognized another traffic participant located within a predetermined distance from a traffic participant determined to have been visually recognized by the driver among the traffic participants.

(8) According to an aspect of the present invention, there is provided a program for causing a computer to: recognize a surrounding situation of a vehicle; estimate a sight line direction of a driver of the vehicle; determine whether or not the driver has visually recognized a traffic participant near the vehicle recognized on the basis of the sight line direction; and determine that the driver has also visually recognized another traffic participant located within a predetermined distance from a traffic participant determined to have been visually recognized by the driver among the traffic participants.

### Advantageous Effects of Invention

According to the above-described aspects (1) to (8), it is possible to more efficiently determine whether or not the driver has visually recognized nearby traffic participants.

### BRIEF DESCRIPTION OF DRAWINGS

FIG. 1 A configuration diagram of a vehicle system 1 using a driving assistance device according to a first embodiment.

FIG. 2 An explanatory diagram of content of a visual recognition determination in the first embodiment.

FIG. 3 An explanatory diagram of an adjustment of a predetermined range.

FIG. 4 A flowchart showing an example of a process of a driving assistance device 100 of the first embodiment.

FIG. 5 An explanatory diagram of content of a visual recognition determination in a second embodiment.

FIG. 6 An explanatory diagram of an adjustment of a fourth predetermined distance in a sight line direction SD2.

FIG. 7 An explanatory diagram of the estimation of a risk value.

FIG. 8 A flowchart showing an example of a process of a driving assistance device 100 of the second embodiment.

### DESCRIPTION OF EMBODIMENTS

Hereinafter, embodiments of a driving assistance device, a driving assistance method, and a program according to the present invention will be described with reference to the drawings. Although a case where left-hand traffic regulations are applied will be described below, it is only necessary to reverse the left and right when right-hand traffic regulations are applied.

### First Embodiment

### [Overall Configuration]

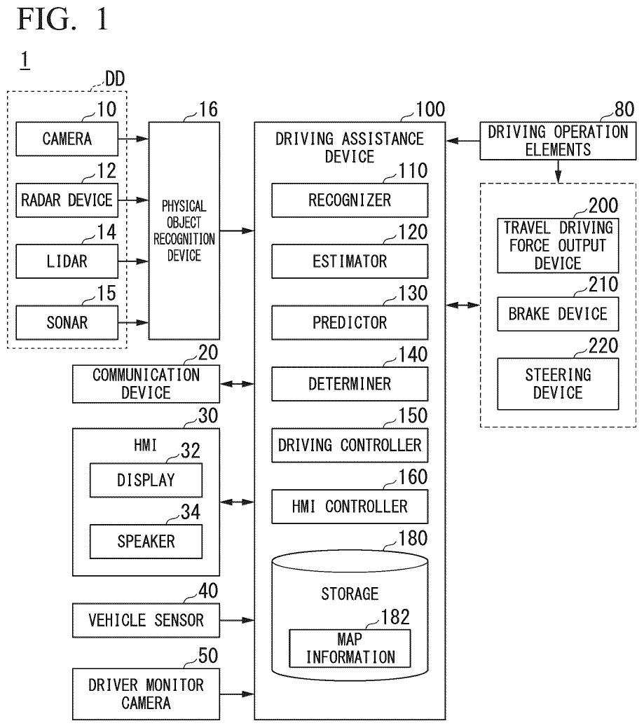

FIG. 1 is a configuration diagram of a vehicle system 1 using a driving assistance device according to a first embodiment. A vehicle (hereinafter referred to as a vehicle M) where the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery or a fuel cell is discharged.

For example, the vehicle system 1 includes a camera 10, a radar device 12, a light detection and ranging (LIDAR) 14, a sonar 15, a physical object recognition device 16, a communication device 20, a human machine interface (HMI) 30, a vehicle sensor 40, a driver monitor camera 50, driving operation elements 80, a driving assistance device 100, a travel driving force output device 200, a brake device 210, and a steering device 220. Such devices and equipment are connected to each other through a multiplex communication line such as a controller area network (CAN) communication line, a serial communication line, a wireless communication network, or the like. In addition, the configuration shown in FIG. 1 is merely an example and some of the constituent elements may be omitted or other constituent elements may be further added. The camera 10, the radar device 12, the LIDAR 14, and the sonar 15 are examples of a “detection device DD.” The detection device DD may include the physical object recognition device 16. The HMI 30 and the HMI controller 160, which will be described below, are examples of a “notifier.”

For example, the camera 10 is a digital camera using a solid-state imaging element such as a charge-coupled device (CCD) or a complementary metal oxide semiconductor (CMOS). The camera 10 is attached to any location on the vehicle M where the vehicle system 1 is mounted. When the view in front of the vehicle M is imaged, the camera 10 is attached to an upper part of a front windshield, a rear surface of a rearview mirror, or the like. Moreover, when the view to the rear of the vehicle M is imaged, the camera 10 is attached to an upper part of a rear windshield or the like.

Moreover, when the view to the right or left side of the vehicle M is imaged, the camera 10 is attached to a right or left side surface of a vehicle body or a door mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position of a physical object (a distance from the physical object and a direction of the physical object) by detecting radio waves (reflected waves) reflected by the physical object. The radar device 12 is attached to any location on the vehicle M. The radar device 12 may detect a position and a speed of the physical object in a frequency-modulated continuous wave (FM-CW) scheme.

The LIDAR 14 radiates light (or electromagnetic waves having a wavelength close to that of light) around the vehicle M and measures scattered light. The LIDAR 14 detects a distance from the target on the basis of a period of time from light emission to light reception. The radiated light is, for example, pulsed laser light. The LIDAR 14 is attached to any location of the vehicle M. In addition, the LIDAR 14 detects the distance from the vehicle M to the target by scanning in the horizontal and vertical directions with respect to the travel direction of the vehicle M.

The sonar 15 detects a distance from the physical object, a position of the physical object, or the like by radiating ultrasonic waves around the vehicle M and detecting the reflection or scattering from a physical object located within a predetermined distance from the vehicle M. The sonar 15, for example, is provided on front and rear ends of the vehicle M and installed on a bumper or the like.

The physical object recognition device 16 recognizes a position, type, and speed of the physical object and the like by performing a sensor fusion process on detection results from some or all of the detection devices DD (the camera 10, the radar device 12, the LIDAR 14, and the sonar 15). The physical object recognition device 16 outputs a recognition result to the driving assistance device 100. The physical object recognition device 16 may output the detection result of the detection device DD to the driving assistance device 100 as it is. In addition, the function of the physical object recognition device 16 may be incorporated into the driving assistance device 100, and the physical object recognition device 16 may be omitted from the vehicle system 1.

The communication device 20, for example, communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 presents various types of information to an occupant of the vehicle and receives an input operation from the occupant. The HMI 30 includes, for example, a display 32 and a speaker 34. The display 32 may be, for example, a meter display in front of the driver's seat or a display device provided in the center of an instrument panel, or a head-up display (HUD). The speaker 34 may be, for example, a sound output device provided in the cabin of the vehicle M. In addition to the display 32 and the speaker 34, the HMI 30 may include a buzzer, a touch panel, a switch, a key, a microphone, and the like.

The vehicle sensor 40 includes a vehicle speed sensor configured to detect the speed of the vehicle M, an acceleration sensor configured to detect acceleration, a yaw rate sensor configured to detect a yaw rate (e.g., an angular velocity of rotation around the vertical axis through a center of gravity of the vehicle M), a direction sensor configured to detect a direction of the vehicle M, and the like. Moreover, a position sensor configured to detect a position of the vehicle M is provided as the vehicle sensor 40. The position sensor is, for example, a sensor configured to acquire position information (longitude/latitude information) from a Global Positioning System (GPS) device. Moreover, the position sensor may be a sensor configured to acquire position information using a global navigation satellite system (GNSS) receiver.

The driver monitor camera 50 is, for example, a digital camera that uses a solid-state image sensor such as a CCD or a CMOS. The driver monitor camera 50 is attached to any location on the vehicle M with respect to a position and a direction where the head of the driver sitting in the driver's seat of the vehicle M can be imaged from the front (in a direction in which his/her face is imaged). For example, the driver monitor camera 50 is attached to the instrument panel of vehicle M, the top of the front windshield, the rearview mirror, the steering wheel, or the like. The driver monitor camera 50 periodically repeatedly captures images including the driver.

For example, the driving operation elements 80 include an accelerator pedal, a brake pedal, a shift lever, and other operation elements in addition to a steering wheel. A sensor configured to detect an amount of operation or the presence or absence of an operation is attached to the driving operation element 80 and a detection result of the sensor is output to the driving assistance device 100 or some or all of the travel driving force output device 200, the brake device 210, and the steering device 220. The steering wheel is an example of an “operation element that receives a steering operation from the driver.” The operation element does not necessarily have to be annular, and may be in the form of a variant steering, a joystick, a button, or the like. Moreover, the driving operation element 80 outputs a steering angle and an amount of steering torque when the driver of the vehicle M steers the steering wheel in a predetermined direction, information indicating that the driver has grasped the steering wheel, and the like to the driving assistance device 100.

The driving assistance device 100 is a device that assists the driver in driving the vehicle M. The driving assistance device 100, for example, includes a recognizer 110, an estimator 120, a predictor 130, a determiner 140, a driving controller 150, an HMI controller 160, and a storage 180. The recognizer 110, the estimator 120, the predictor 130, the determiner 140, the driving controller 150, and the HMI controller 160 are implemented, for example, by a hardware processor such as a central processing unit (CPU) executing a program (software). Some or all of these constituent elements may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as a hard disk drive (HDD) or a flash memory of the driving assistance device 100 or may be stored in a removable storage medium such as a digital video disc (DVD) or a compact disc-read-only memory (CD-ROM) and installed in the HDD or the flash memory of the driving assistance device 100 when the storage medium (a non-transitory storage medium) is mounted on a drive device.

The storage 180 may be implemented by the above-described various types of storage devices, an electrically erasable programmable read-only memory (EEPROM), a read-only memory (ROM), a random-access memory (RAM), or the like. The storage 180, for example, stores information, programs, and other various types of information required to execute various types of control in the embodiment. Moreover, the storage 180 may include map information 182. The map information 182 is, for example, information in which the road shape is expressed by links indicating roads in a predetermined segment and nodes connected by the links. Moreover, the map information 182 may include point of interest (POI) information in accordance with the position information or may include information about road shapes and road structures and the like. The road shapes include, for example, branching and merging, tunnels (entrances and exits), curved roads (entrances and exits), curvature, radius of curvature, the number of lanes, widths, and gradients of roads or road markings (hereinafter referred to as “markings”) and the like. Information about road structures may include, for example, information about a type, a position, an orientation in a road extension direction, a size, a shape, a color, and the like of each of the road structures. In the type of road structure, for example, the marking may be used as a type, and each of the lane marks belonging to the marking, curbs, medians, and walls (including fences and the like) installed along the extension direction of the road may be used as different types. The map information 182 may be updated at any time by the communication device 20 communicating with other devices.

The recognizer 110 recognizes a surrounding situation of the vehicle M on the basis of information input from some or all of the detection devices DD, or information input via the physical object recognition device 16. For example, the recognizer 110 recognizes states of a position, size, shape, speed, acceleration, and the like of a physical object located in the vicinity of the vehicle M (within a first predetermined distance). The position of the physical object, for example, may be recognized as a position of an absolute coordinate system having a representative point of the vehicle M (a center of gravity, a drive shaft center, or the like) as the origin. The position of the physical object may be represented by a representative point such as the center of gravity or a corner of the physical object or a distal end of a progress direction or may be represented by an area that has been represented. For example, the “state” of the physical object may include the acceleration or jerk of the physical object, or the “action state” (e.g., whether or not the vehicle is changing lanes or is about to change lanes) when the physical object is a mobile object such as another vehicle.

Moreover, the recognizer 110 recognizes attributes of a physical object by matching feature information such as the size, shape, color, and speed of the physical object with attribute patterns associated with the feature information in advance and the like. The attributes of the physical object, for example, may be a type of vehicle, pedestrian, utility pole, and the like or may be a type for identifying a four-wheeled vehicle, two-wheeled vehicle, bicycle, or electric kickboard for each vehicle. Moreover, when a pedestrian has been recognized, the recognizer 110 may recognize whether the pedestrian is an adult, a child, an elderly person, or the like as each separate attribute from a size (for example, a height), a shape, an amount of movement, or the like.

Moreover, the recognizer 110 may recognize a physical object that is a traffic participant on the basis of attributes and the like. Traffic participants are not limited to, for example, pedestrians on a road on which the vehicle M is traveling, and may also include other mobile objects such as bicycles, motorcycles, and automobiles. Moreover, when a predetermined number or more of traffic participants with a specific attribute are located within a predetermined range, the recognizer 110 may cluster the traffic participants with the specific attribute located within the predetermined range as a group.

Moreover, the recognizer 110 recognizes a road situation around the vehicle M on the basis of information input from some or all of the detection devices DD or information input via the physical object recognition device 16. The road situations are situations such as positions of markings that divide the road, a position of a road boundary, and an area from the marking to the road boundary (e.g., roadside strips and shoulders). Moreover, the recognizer 110 may recognize a distance between the recognized physical object and the marking, a distance between the physical object and the road boundary, and the like. Moreover, the recognizer 110 may recognize the lane in which the vehicle M is traveling and adjacent lanes.

Moreover, the recognizer 110 may refer to the map information 182 stored in the storage 180 on the basis of the position information of the vehicle M obtained from the position sensor of the vehicle sensor 40 and recognize a situation of the road on which the vehicle M is traveling (for example, the position of the marking) and the like from the map information 182. Moreover, the recognizer 110 may recognize the road situation around the vehicle M by comparing the recognition result from the above-described detection device DD or the like with a recognition result obtained from the map information 182.

The estimator 120 detects a positional relationship between the driver's head and eyes, a combination of a reference point and a moving point in the eyes, and the like from the image of the driver monitor camera 50 using a method such as template matching. Also, the estimator 120 estimates a face direction on the basis of a relative position of the eyes to the head. Moreover, the estimator 120 estimates the driver's sight line direction on the basis of the position of the moving point for the reference point. For example, when the reference point is an inner corner of the eye, the moving point is the iris. Moreover, when the reference point is a corneal reflection area, the moving point is the pupil. Moreover, the estimator 120 may estimate a gaze point on the basis of a sight line direction. Moreover, the estimator 120 may estimate a visual field range of the driver (a predetermined range around the sight line direction) on the basis of the sight line direction. The visual field range is, for example, a range that extends in the sight line direction with the eye position (or an intermediate position between the two eyes) of the driver of the vehicle M or the center position of the driver's face or head as a vertex, and widens at a predetermined angle as a distance from the driver increases.

The predictor 130 predicts a future (after the elapse of a first predetermined time) action (e.g., a position, a speed, and a movement direction) of the traffic participant recognized by the recognizer 110. For example, the predictor 130 may predict the future action on the basis of the amount of movement (e.g., a speed) and the movement direction of the same traffic participant up to the last moment, or may predict the future action on the basis of an action pattern preset in accordance with the attributes of the traffic participant, the road shape, and the like. The action pattern is, for example, a pattern in which if the attribute is a bicycle, there is a high possibility that the traffic participant will continue moving in the same direction, or a traffic participant will decelerate before an intersection or the like.

Moreover, when the recognizer 110 recognizes a plurality of traffic participants as a group, the predictor 130 predicts a future action for each group. In this case, the predictor 130, for example, predicts a future position of the group on the basis of an average speed and an average position of the traffic participants included in the group.

Moreover, the predictor 130 may increase a weight of a speed or position of the traffic participant in a group of traffic participants who are closer to the vehicle M among the plurality of traffic participants included in the group. Thereby, because the speed or position of the traffic participants closer to the vehicle M is given higher priority and the future speed or position of the group is predicted, the more appropriate visual recognition determination and notification for the driver and the like can be performed. Moreover, the predictor 130 may predict the future position or speed of the vehicle M on the basis of the position and speed VM of the vehicle M.

The determiner 140 determines whether or not the driver has visually recognized traffic participants near the vehicle M recognized by the recognizer 110 on the basis of the sight line direction of the driver of the vehicle M estimated by the estimator 120.

Moreover, when the recognizer 110 recognizes a plurality of traffic participants as a group, the determiner 140 determines whether or not the driver has visually recognized the traffic participants on the basis of the group. Details of the process of the determiner 140 will be described below.

The driving controller 150 automatically controls one or both of the steering and acceleration/deceleration of the vehicle M to execute driving control on the basis of a recognition result of the recognizer 110 or a determination result of the determiner 140. Moreover, when an operation for executing at least one of various types of driving assistance is received by the HMI 30, the driving controller 150 may execute driving assistance corresponding to content of the received operation. The driving assistance executed by the driving controller 150 may include various types of driving control such as, for example, adaptive cruise control (ACC), lane keeping assistance system (LKAS), lane change assist (LCA), forward collision warning (FCW), and collision mitigation braking system (CMBS).

The HMI controller 160 acquires information received by the HMI 30 and causes the HMI 30 to output predetermined information, thereby performing a process for notifying an occupant (the driver or the like) of the vehicle M of the information or the like. The predetermined information includes, for example, a recognition result of the recognizer 110, a determination result of the determiner 140, and the like.

Moreover, the predetermined information may include information about the traveling of the vehicle M, such as information about the state of the vehicle M and driving assistance information. The information about the state of the vehicle M includes, for example, information about the speed of the vehicle M, an engine speed, a shift position, and the like. Moreover, the driving assistance information, for example, includes information (attention alert information) for informing the driver of the presence of a physical object (a traffic participant or the like) near the vehicle M, information for supporting the driver in a steering operation or a speed operation for avoiding contact between the vehicle M and the physical object, and the like. Moreover, the predetermined information may include information not related to the driving control of the vehicle M, such as television programs and other content (e.g., a sound and a video) received by the communication device 20 or the like. Moreover, the predetermined information may include, for example, information about a current position and destination of the vehicle M, and the remaining amount of fuel.

For example, the HMI controller 160 may generate an image including the predetermined information described above and cause the display 32 of the HMI 30 to display the generated image or may generate a sound indicating the predetermined information (including an alarm sound and the like) and cause the generated sound to be output from the speaker 34 of the HMI 30.

The travel driving force output device 200 outputs a travel driving force (torque) for enabling the traveling of the vehicle M to driving wheels. For example, the travel driving force output device 200 includes a combination of an internal combustion engine, an electric motor, a transmission, and the like mounted on the vehicle M, and an electronic control unit (ECU) that controls the internal combustion engine, the electric motor, the transmission, and the like. The ECU controls the above-described constituent elements in accordance with information input from the driving controller 150 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the driving controller 150 or the information input from the brake pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the driving controller 150 and transfer the hydraulic pressure of the master cylinder to the cylinder.

For example, the steering device 220 includes a steering ECU and an electric motor. For example, the electric motor changes a direction of steered wheels by applying a force to a rack and pinion mechanism. The steering ECU drives the electric motor in accordance with the information input from the driving controller 160 or the information input from the steering wheel that is the driving operation element 80 to change the direction of the steered wheels.

### [Visual Recognition Determination of Traffic Participants in First Embodiment]

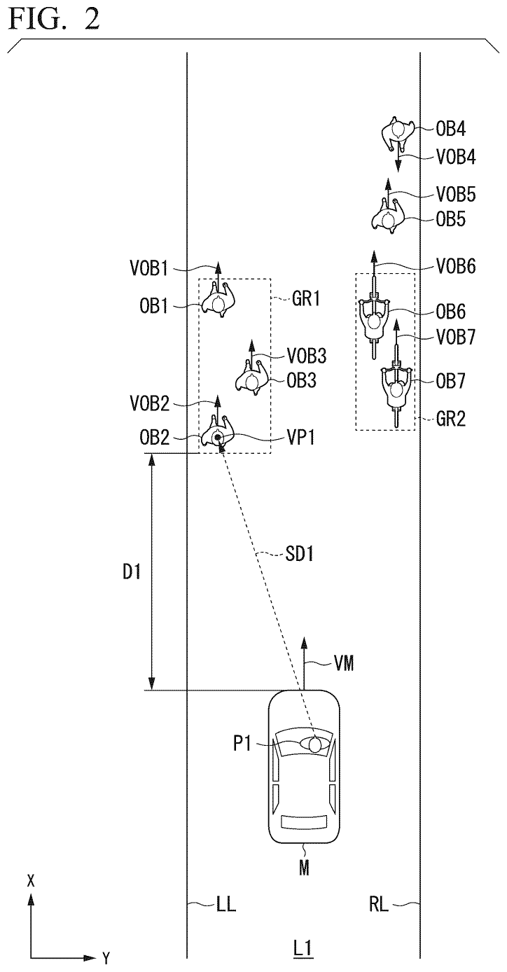

Next, a visual recognition determination for traffic participants in the first embodiment will be described with reference to the drawings. FIG. 2 is an explanatory diagram of content of the visual recognition determination in the first embodiment. In the example of FIG. 2, it is assumed that the vehicle M driven by a driver P1 is traveling in a lane L1 at a speed VM in an extension direction (an X-axis direction in the drawing) (hereinafter, the lane L1 may be referred to as a “travel lane L1”). The travel lane L1 is defined by markings LL and RL. Moreover, in the example of FIG. 2, traffic participants OB1 to OB7 are located near the vehicle M. Attributes of the traffic participants OB1 to OB5 are pedestrians and attributes of the traffic participants OB6 to OB7 are bicycles. It is assumed that the traffic participants OB1 to OB7 are moving in directions of arrows shown in FIG. 2 at speeds VOB1 to VOB7, respectively.

In the example of FIG. 2, the recognizer 110 recognizes a position or speed VM of the vehicle M relative to the travel lane L1. Moreover, the recognizer 110 recognizes positions or speeds VOB1 to VOB7 of the traffic participants OB1 to OB7 located near the vehicle M (for example, in a travel direction (a forward direction) of the vehicle M and within a first predetermined distance). Moreover, the recognizer 110 recognizes the attributes of the traffic participants OB1 to OB7.

Moreover, the recognizer 110 recognizes (clusters) traffic participants as a group when a predetermined number or more of traffic participants with a specific attribute are located within a predetermined range among the recognized traffic participants OB1 to OB7. The specific attribute is, for example, the same type of attribute. Moreover, the specific attribute may be an attribute (for example, a pedestrian) that has a small amount of movement (a speed is less than a threshold value) in a predetermined time (a second predetermined time) and is likely to come close to the vehicle M. Moreover, in addition to the above-described conditions, the specific attribute may include that the error in the travel direction of the traffic participant is less than a threshold value or that an increased amount in the relative position between the traffic participants in a predetermined time (a third predetermined time) is less than a predetermined amount, and the like. In addition, the above-described movement amount, travel direction, and increased amount in the relative position may include a future action prediction result predicted by the predictor 130. Moreover, the predetermined number may be a fixed value (e.g., 2), or may be variably set in accordance with the total number of traffic participants recognized by the recognizer 110, a road situation, a speed of the vehicle M or the traffic participant, a distance between the vehicle M and the traffic participant, or the like.

In the example of FIG. 2, the recognizer 110 recognizes the traffic participants OB1 to OB3 having the same attribute as pedestrians and located within a predetermined range as a group GR1. Moreover, the recognizer 110 recognizes traffic participants having the same attribute as bicycles and located within a predetermined range as a group GR2. In the example of FIG. 2, because the traffic participants OB5 and OB6 are located within the predetermined range but have different attributes, they are not recognized as a group.

Moreover, in the example of FIG. 2, the traffic participants OB4 and OB5 have the same attribute (pedestrians) and are located within a predetermined range, but are moving in opposite movement directions (an error between their movement directions is equal to or greater than a threshold value (a first threshold value)), and there is a high possibility that their positions will be outside the predetermined range in the near future. For this reason, the recognizer 110 may not recognize the traffic participants OB4 and OB5 as a group when the future positions (after a first predetermined time) predicted by the predictor 130 will be outside the predetermined range. Hereinafter, it is assumed that the traffic participants OB4 and OB5 are not recognized as a group by the recognizer (each traffic participant is recognized as an individual traffic participant).

The determiner 140, for example, determines whether or not the driver P1 of the vehicle M has visually recognized the traffic participants OB1 to OB7 on the basis of the sight line direction of the driver P1 and the positions of the traffic participants OB1 to OB7 recognized by the recognizer 110. For example, the determiner 140 projects a sight line direction SD1 of the driver P1 of the vehicle M onto an image plane of the image captured by the camera 10 (hereinafter, a camera image) on the basis of a position of the vehicle M, a position of the driver P1 in the vehicle cabin, a position of the camera 10 mounted on the vehicle M, and the like and determines that the driver Pl has visually recognized the traffic participant when the traffic participant is located in the projected sight line direction SD1. A case where the traffic participant is located in the projected sight line direction SD1 is, for example, a case where at least a part of a visual field range or a gaze point on the image plane based on the projected sight line direction SD1 is included (overlaps) in the area of the traffic participant on the image plane. Moreover, the determiner 140 determines that the traffic participant has not been visually recognized when the traffic participant is not located in the projected sight line direction SD1.

In addition, the determiner 140 may determine that the traffic participant has been visually recognized when the traffic participant has been located in the sight line direction SD1 continuously for a predetermined time (a fourth predetermined time) or more. Thereby, it is possible to suppress a process in which the driver P1 erroneously determines that he or she has visually recognized a traffic participant that he or she is likely to have missed.

Moreover, when a predetermined number of traffic participants are recognized as a group by the recognizer 110, the determiner 140 determines that the driver P1 has visually recognized all of the traffic participants included in the group when at least some of the traffic participants in the group are located in the sight line direction SD1 of the driver P1. Moreover, the determiner 140 determines that the driver P1 has not visually recognized all traffic participants included in the group when at least some of the traffic participants in the group are not located in the sight line direction SD1 of the driver P1.

In the example of FIG. 2, the traffic participant OB2 among the three traffic participants OB1 to OB3 included in the group GR1 is located in the sight line direction SD1 (a gaze point VP1) of the driver P1 of the vehicle M. Therefore, the determiner 140 determines that driver P1 has visually recognized all of the traffic participants OB 1 to OB3 included in the group GR1. Moreover, in the example of FIG. 2, the determiner 140 determines that the driver P1 has not visually recognized the traffic participants OB4 to OB7.

When there is a traffic participant whose relative distance from the vehicle M is less than a predetermined distance (a second predetermined distance) among the traffic participant OB4 to OB7 determined not to have been visually recognized by the driver P1 or when there is a traffic participant whose time to contact (TTC) with the vehicle M is less than a threshold value, the HMI controller 160 notifies the driver P1 of information indicating that the traffic participant is located near the vehicle M, information indicating a direction in which the traffic participant is located as seen from the vehicle M, information indicating an attribute of the traffic participant or the like, information for alerting attention, or the like by causing the HMI 30 to output an image, a sound, or the like. The time to contact (TTC) is, for example, a value calculated by dividing the relative distance between the vehicle M and the traffic participant by the relative speed.

Moreover, when a plurality of traffic participants are recognized as a group by the recognizer 110, the HMI controller 160 may perform a determination related to the notification described above on the basis of the position or speed of the group. For example, in the example of FIG. 2, the determination related to the above-described notification is executed on the basis of a position (e.g., an average position between the traffic participants OB6 and OB7) or speed (e.g., an average speed between the speeds VOB6 and VOB7) of the group GR2 to which the traffic participants OB6 and OB7 belong.

Moreover, in addition to (or instead of) the above-described notification, the HMI controller 160 may provide a notification of information about a driving operation for the vehicle M to avoid contact with the traffic participant. Moreover, the HMI controller 160 ends the notification when it is determined that the driver P1 has visually recognized the traffic participant after the notification. Moreover, the determiner 140 may determine whether or not the driver will visually recognize the traffic participant in the near future on the basis of a future position of the traffic participant (or a group) predicted by the predictor 130 and a sight line direction of the driver P1. When it is determined that the driver will visually recognize the traffic participant in the near future, the HMI controller 160 may perform control so that a notification is not provided to the traffic participant.

Moreover, when there is a traffic participant whose relative distance from the vehicle M is less than a second predetermined distance or when there is a traffic participant whose time to contact (TTC) with the vehicle M is less than a threshold value (a second threshold value), the driving controller 150 may control one or both of the steering and speed of the vehicle M to execute driving control for avoiding contact between the vehicle M and the traffic participant (or group). In this case, the driving controller 150 may execute driving control for avoiding contact on the basis of the future action prediction result of the traffic participant (or group) predicted by the predictor 130.

In this way, when there are a predetermined number or more of traffic participants with a specific attribute near the vehicle M within a predetermined range, because they are recognized as a group and a visual recognition determination is performed in units of groups, it is possible to implement a more efficient visual recognition determination without performing the visual recognition determination on each traffic participant predicted to be included in the visual field range. Moreover, because the processing load of the visual recognition determination can be reduced and the processing time can be shortened, a notification of information about traffic participants and the like that the driver P1 has overlooked can be provided to the driver P1 at a more appropriate timing.

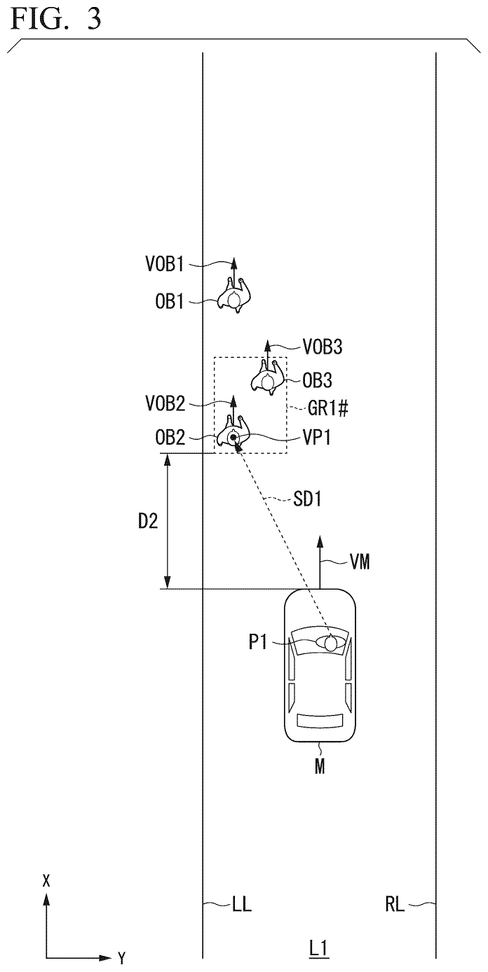

In addition, the above-described predetermined range in the first embodiment may be adjusted, for example, in accordance with the distance from the vehicle M to a traffic participant with a specific attribute (a traffic participant for which it is determined whether or not to include the traffic participant in a group). FIG. 3 is an explanatory diagram of the adjustment of the predetermined range. In the example of FIG. 3, the vehicle M located in the lane L1 shown in FIG. 2 and the traffic participants OB1 to OB3 are shown. Because the visual field range becomes wider at a predetermined angle when the distance from the driver P1 is longer, the visual field range conversely becomes narrower when the distance from the gaze point VP1 is shorter. Therefore, the recognizer 110 narrows a range (a predetermined range) for recognizing the traffic participants as one group as the distance from the traffic participants decreases. Alternatively, in contrast, the predetermined range for recognizing the traffic participants as one group may be widened as the distance from the traffic participants increases.

For example, in the example of FIG. 3, a distance D2 in the extension direction of the travel lane L1 between the vehicle M and the traffic participant OB2 closest to the vehicle M is shorter than the distance D1 shown in FIG. 2. In other words, the distance from the driver P1 to the traffic participant OB2 is shorter than in the situation shown in FIG. 2. Therefore, the recognizer 110 reduces a predetermined area to be recognized as a group, recognizes the traffic participants OB2 and OB3 as a group GR1#, and recognizes the traffic participant OB1 by excluding it from the group GR1#. Thereby, it is possible to recognize a plurality of traffic participants as a group within a range according to the visual field range and further suppress an erroneous visual recognition determination.

Moreover, the recognizer 110 may reduce the number of traffic participants included in a group as the distance from the vehicle M becomes closer or may not recognize the traffic participants as a group when the distance from the vehicle M to the traffic participants is shorter than a predetermined distance (a third predetermined distance). Thereby, because the number of traffic participants in a group closer to the vehicle M is smaller or a visual recognition determination is performed on individual traffic participants without recognizing them as a group, the accuracy of the visual recognition determination can be improved for traffic participants closer to the vehicle M and appropriate driving assistance can be provided by notifications or the like.

### [Processing Flow]

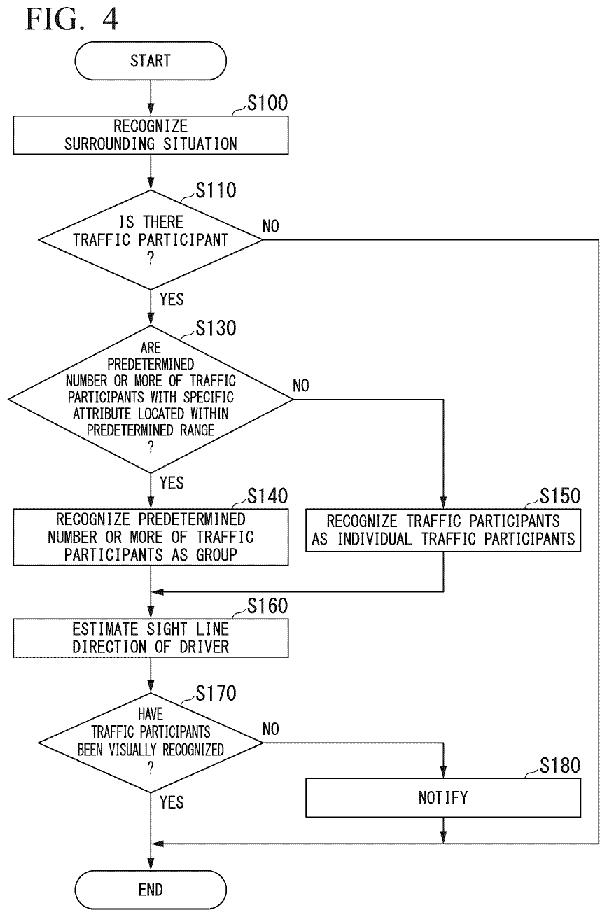

Hereinafter, a flow of a series of processing steps performed by the driving assistance device 100 of the first embodiment will be described using a flowchart. FIG. 4 is a flowchart showing an example of a process performed by the driving assistance device 100 of the first embodiment. Hereinafter, the visual recognition determination process in the first embodiment will be mainly described among the processes performed by the driving assistance device 100. The process of the present flowchart, for example, may be iteratively executed at predetermined timings or intervals.

In the example of FIG. 4, the recognizer 110 recognizes a surrounding situation of the vehicle M (step S100). Subsequently, the determiner 140 determines whether or not there is a traffic participant in a travel direction (e.g., a forward direction) of the vehicle M (step S110). When it is determined that there is a traffic participant, the determiner 140 determines whether or not a predetermined number or more of traffic participants with a specific attribute are located within a predetermined range (step S130). When it is determined that a predetermined number or more of traffic participants with a specific attribute are located within a predetermined range, the recognizer 110 recognizes a predetermined number of traffic participants as a group (step S140). Moreover, when it is determined that a predetermined number or more of traffic participants with a specific attribute are not located within the predetermined range in the processing of step S130, the recognizer 110 recognizes the recognized traffic participants as individual traffic participants (step S150).

After the processing of step S140 or S150, the estimator 120 estimates the sight line direction of the driver of the vehicle M (step S160). Subsequently, the determiner 140 determines whether or not the traffic participants have been visually recognized on the basis of the sight line direction of the driver and the traffic participants recognized by the recognizer 110 (step S170). In addition, in the processing of step S170, when the recognizer 110 recognizes a predetermined number (a plurality) of traffic participants as a group, the determiner 140 determines whether or not at least some (one) of the traffic participants included in the group have been visually recognized. When it is determined that a traffic participant has not been visually recognized, the HMI controller 160 generates an image or a sound to notify the driver of the presence of the traffic participant and outputs the image and sound to the HMI 30 to provide a notification to the driver (step S180). Thereby, the processing of the present flowchart ends.

Moreover, when it is determined that there is no traffic participant in the processing of step S110 or when it is determined that a traffic participant has been visually recognized in the processing of step S170, the process of the present flowchart ends.

According to the first embodiment described above, the driving assistance device 100 includes the recognizer 110 configured to recognize a surrounding situation of the vehicle M; the estimator 120 configured to estimate a sight line direction of a driver of the vehicle M; and the determiner 140 configured to determine whether or not the driver has visually recognized a traffic participant near the vehicle M recognized by the recognizer 110 on the basis of the sight line direction, wherein the recognizer 110 recognizes traffic participants located in a predetermined range as a group when there are a predetermined number or more of traffic participants with a specific attribute in the predetermined range among the traffic participants, and wherein the determiner 140 determines that the driver has visually recognized the traffic participant included in the group when there are at least some of the traffic participants included in the group in the sight line direction of the driver, whereby the driver can more efficiently determine whether or not the driver has recognized a nearby traffic participant.

For example, according to the first embodiment, it is unnecessary to perform a visual recognition determination for each traffic participant and it is possible to cluster a plurality of traffic participants as a group without communicating with the traffic participants. Thereby, it is possible to reduce the processing load related to the visual recognition determination and shorten the processing time. Moreover, according to the first embodiment, a notification of the presence of nearby traffic participants can be more appropriately provided to the driver of the vehicle.

### Second Embodiment

Next, a second embodiment of the driving assistance device 100 will be described. In the second embodiment, a configuration similar to that of the vehicle system 1 (the driving assistance device 100) shown in FIG. 1 can be applied. Therefore, in the second embodiment, a configuration similar to that of the vehicle system 1 shown in FIG. 1 is used, differences from the first embodiment will be mainly described, and other descriptions will be omitted.

### [Determination of Visual Recognition of Traffic Participants in Second Embodiment]

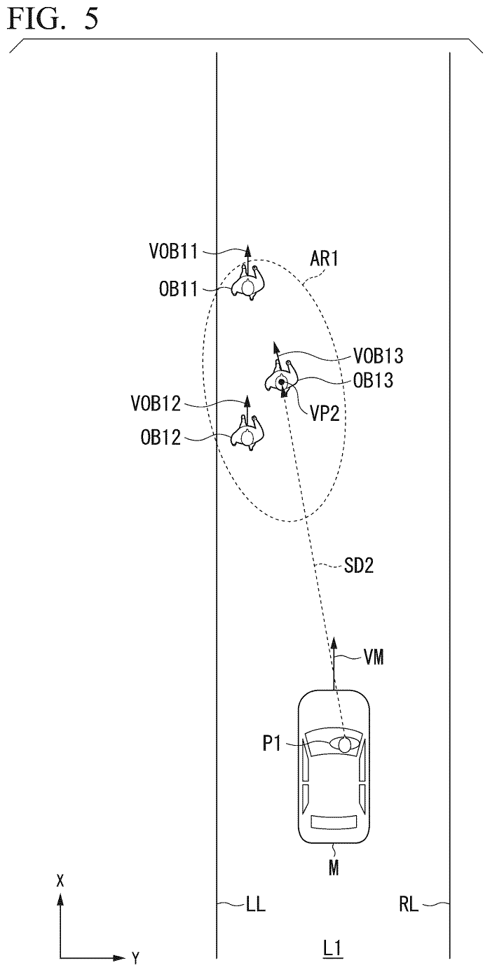

In the second embodiment, when there is a traffic participant for which it is determined that the driver has visually recognized among the traffic participants recognized by the recognizer 110, the determiner 140 determines that the driver has also visually recognized another traffic participant located within a predetermined distance (a fourth predetermined distance) from the traffic participant. FIG. 5 is an explanatory diagram of content of a visual recognition determination in the second embodiment. In the example of FIG. 5, traffic participants OB11 to OB13 are located in front of a vehicle M driven by a driver P1 and traveling at a speed VM along a lane L1 in an extension direction. The traffic participants OB11 to OB13 are moving in directions of arrows shown in FIG. 5 at speeds VOB11 to VOB13, respectively.

As shown in the example of FIG. 5, when the traffic participant OB13 is located in a sight line direction SD2 of the driver P1 of the vehicle M, the determiner 140 determines that the traffic participant OB 13 has been visually recognized. In this case, when another traffic participant is located within the fourth predetermined distance on the basis of the position of the traffic participant OB13 (e.g., a gaze point VP2 projected by the sight line direction SD2 onto the screen plane of the camera image or the center position of the image area of the traffic participant OB13), the determiner 140 determines that the other traffic participant has also been visually recognized. In the example of FIG. 5, an area AR1 within the fourth predetermined distance from the position of the traffic participant OB13 is shown. The determiner 140 determines that the other traffic participants OB11 to OB12 located within the area AR1 have also been visually recognized. Thereby, it is unnecessary to determine whether or not each traffic participant has been visually recognized and it is possible to perform an efficient visual recognition determination, reduce the processing load, and shorten the processing time.

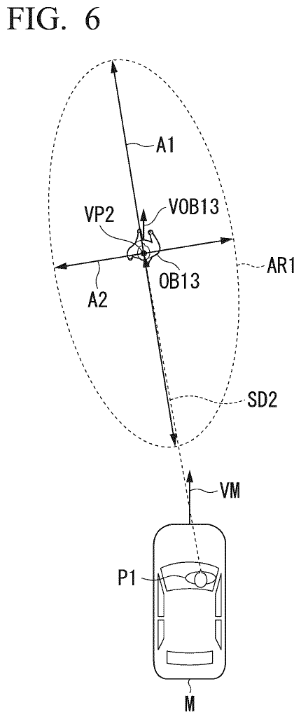

In addition, the fourth predetermined distance may be adjusted in accordance with the sight line direction SD2 of the driver P1 and the like. FIG. 6 is an explanatory diagram of an adjustment of the fourth predetermined distance in the sight line direction SD2. For example, the fourth predetermined distance is made different between a direction extending in the sight line direction SD2 of the driver P1 and a direction perpendicular to the sight line direction SD2. For example, a physical object near the extension direction of the sight line direction SD2 (the gaze point VP2) has high visibility. When the physical object is farther away from the sight line direction SD2 (the visual field angle is larger), the visibility of the physical object becomes low. Therefore, an adjustment is made so that the fourth predetermined distance is longer when the direction from the reference position (e.g., the position of the visually recognized traffic participant OB13) is closer to the direction extending in the sight line direction SD2 and shorter when it is closer to a direction perpendicular to the sight line direction SD.

Although the area AR1 in which the fourth predetermined distance has been adjusted is shown in an ellipse shape with a long diameter A1 and a short diameter A2 centered on the position of the traffic participant OB13 located in the sight line direction SD2 in the example of FIG. 6, the present invention is not limited thereto. For example, the distance in front of and behind the traffic participant OB3 or the distance between the left and right sides may be varied on the basis of the road shape or the position and speed VOB13 of the traffic participant OB13 visually recognized on the road. Moreover, the outer periphery of the area ARI may be formed in a non-curved shape instead of a curved shape. Thereby, it is possible to determine that other traffic participants located at a position where the driver P1 is predicted to have a higher degree of visibility have been visually recognized at the same time.

Although the determiner 140 also determines that a nearby traffic participant (within the fourth predetermined distance) has also been visually recognized when it is determined that one of a plurality of traffic participants has been visually recognized in the second embodiment, it may be determined that the other traffic participant has not been visually recognized when a risk value of another traffic participant located within the fourth predetermined distance is equal to or greater than a threshold value. The risk value is, for example, an index value indicating the degree of possibility of contact with the vehicle M based on an amount of movement of the traffic participant or an action prediction result. In addition, in the second embodiment, the risk value is estimated by the estimator 120.

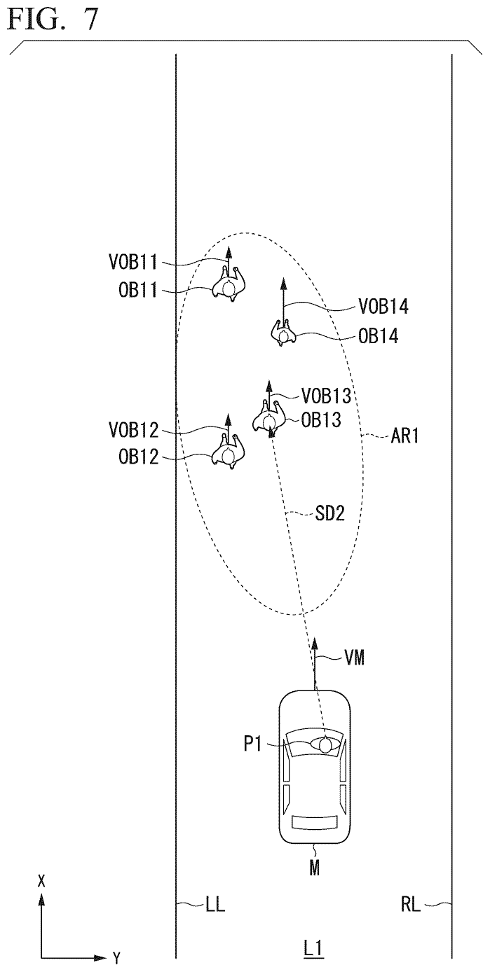

FIG. 7 is an explanatory diagram of the estimation of risk values. In the example of FIG. 7, traffic participants OB11 to OB14 are located within the travel lane L1 of the vehicle M in the travel direction (forward direction) of the vehicle M. Moreover, in the example of FIG. 7, it is assumed that other traffic participants OB11, OB12, and OB14 are located within the area AR1 of the fourth predetermined distance based on the traffic participant OB13 located in the sight line direction SD2 of the driver P1.

In this case, the estimator 120 estimates a risk value of each of the other traffic participants OB11, OB12, and OB14. For example, the estimator 120 estimates the risk value according to the amount of movement based on the speed VOB of the other traffic participant. In this case, the estimator 120 increases the risk value as the amount of movement increases. Moreover, the estimator 120 may estimate the risk value including a future amount of movement based on the action prediction result of the predictor 130 in addition to the current speed (the amount of movement) of the traffic participant.

Moreover, the estimator 120 may estimate the risk value in accordance with the attribute of the traffic participant. In this case, the estimator 120 increases the risk value when the attribute of the traffic participant is a child compared to when the attribute of the traffic participant is an adult. Moreover, the estimator 120 may set a larger risk value for a traffic participant whose attribute is a bicycle than for a pedestrian. When the traffic participant is closer to the center of the travel lane L1 of the vehicle M, the risk value may become larger. Moreover, the estimator 120 may set a larger risk value for a traffic participant who is likely to come into contact with another traffic participant on the basis of the predicted future position of the vehicle M predicted by the predictor 130 and a future action prediction result for the traffic participant. The estimator 120 may estimate a final risk value by combining several setting conditions for each risk value described above.

In the example of FIG. 7, it is assumed that the risk value is greater than or equal to the threshold value because the traffic participant OB14 is a child and is located near the center of the lane and the risk values of the traffic participants OB11 and OB12 are less than the threshold value. In this case, in the example of FIG. 7, when it is determined that the driver Pl has visually recognized the traffic participant OB13, the determiner 140 also determines that the driver P1 has visually recognized the traffic participants OB11 and OB12 located within the fourth predetermined distance (within the area AR1) from the traffic participant OB13, but determines that the driver P1 has not visually recognized the traffic participant OB14.

When a relative distance between the vehicle M and a traffic participant determined not to be visually recognized by the driver P1 is located within a predetermined distance (a fifth predetermined distance) or when the time to contact (TTC) for that traffic participant is less than a threshold value (a third threshold value), the HMI controller 160 provides a notification to the driver P1 by causing the HMI 30 to output information (an image and/or a sound) indicating the presence of the traffic participant.

Moreover, when there is a traffic participant whose relative distance from vehicle M is less than the fifth predetermined distance or when there is a traffic participant whose time to contact (TTC) with the vehicle M is less than the third threshold value, the driving controller 150 may control one or both of the steering and speed of vehicle M to execute driving control for avoiding contact between the vehicle M and traffic participants (or a group).

### [Processing Flow]

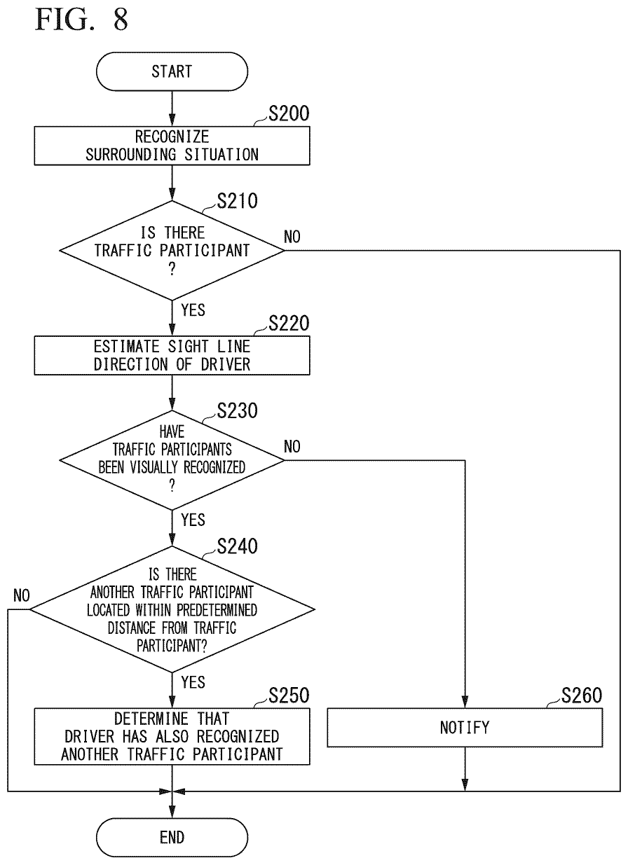

A series of processing steps performed by the driving assistance device 100 of the second embodiment will be described below with reference to a flowchart. FIG. 8 is a flowchart showing an example of a process of the driving assistance device 100 of the second embodiment. Hereinafter, a visual recognition determination process in the second embodiment will be mainly described. The process of the present flowchart may be iteratively executed, for example, at predetermined timings or intervals.

In the example of FIG. 8, the recognizer 110 recognizes a surrounding situation of the vehicle M (step S200). Subsequently, the determiner 140 determines whether or not a traffic participant is located in a travel direction (e.g., a forward direction) of the vehicle M (step S210). When it is determined that a traffic participant is located in the travel direction of the vehicle M, the estimator 120 estimates a visual recognition direction of the driver of the vehicle M (step S220). Subsequently, the determiner 140 determines whether or not the traffic participant has been visually recognized on the basis of an estimated visual recognition direction of the driver, a position of the traffic participant, and the like (step S230). When it is determined that the traffic participant has been visually recognized, the determiner 140 determines whether or not there is another traffic participant located within the predetermined distance (the fourth predetermined distance) from the traffic participant (step S240). When it is determined that there is another traffic participant, it is determined that the driver has also recognized the other traffic participant (step S250).

Moreover, when it is determined that the traffic participant has not been visually recognized in the processing of step S230, the HMI controller 160 causes the HMI 30 to output information indicating the presence of the traffic participant and provides a notification to the driver (step S260). Thereby, the process of the present flowchart ends. Also, when there is no traffic participant in the processing of step S210 or when it is determined that there is no other traffic participant located within the fourth predetermined distance from the traffic participant in the processing of step S240, the process of the present flowchart ends.

According to the second embodiment described above, the driving assistance device 100 includes the recognizer 110 configured to recognize a surrounding situation of the vehicle M; the estimator 120 configured to estimate a sight line direction of a driver of the vehicle M; and the determiner 140 configured to determine whether or not the driver has visually recognized a traffic participant near the vehicle M recognized by the recognizer 110 on the basis of the sight line direction, wherein the determiner 140 determines that the driver has also visually recognized another traffic participant located within a fourth predetermined distance from a traffic participant determined to have been visually recognized by the driver among the traffic participants, whereby the driver can more efficiently determine whether or not the driver has recognized a nearby traffic participant.

For example, according to the second embodiment, it is possible to determine that another traffic participant located near the traffic participant that has been visually recognized and is likely to be visually recognized has been visually recognized by adjusting the above-described predetermined distance in accordance with the driver's sight line direction. Thereby, it is possible to improve the accuracy of the visual recognition determination process and to reduce the processing load and the processing time. Moreover, according to the second embodiment, it is possible to more appropriately notify the vehicle driver of the presence of traffic participants located in a nearby area.

### [Modification Example]

Each of the above-described first and second embodiments may be combined with some or all of the other embodiments. For example, the visual recognition determination may be switched between the visual recognition determination in the first embodiment (a first visual recognition determination) and the visual recognition determination in the second embodiment (a second visual recognition determination) in accordance with an attribute of a traffic participant located in a nearby area. Moreover, the visual recognition determination may be switched between the first and second visual recognition determinations in accordance with the speed of the traffic participants, the number of traffic participants recognized by the recognizer 110, and a road situation.

Moreover, in the first and second embodiments described above, when a traffic participant is stopped or moving at less than a predetermined speed, there is a high possibility that the traffic participant has already noticed the vehicle M and stopped or decelerated and a possibility of contact with the vehicle M is low compared to when the traffic participant is moving at a predetermined speed or higher. Therefore, the HMI controller 160 may provide a notification when there is a traffic participant who is determined not to have been visually recognized by the driver and whose speed is higher than or equal to a predetermined speed. Thereby, it is possible to provide a priority notification of traffic participants who are more likely to come into contact.

Moreover, in the second embodiment, the determiner 140 may set the area AR1 within a predetermined distance based on the traffic participants determined to have been visually recognized by the driver as a visually recognized area. In this case, the determiner 140 determines that traffic participants who have entered the area AR1 later have also been visually recognized until a predetermined time has elapsed after the area AR1 was set as a visually recognized area. Moreover, when a traffic participant that is a reference for the visually recognized area moves, a position of the area AR1 may also be moved to follow the traffic participant. Thereby, it is possible to treat not just individual traffic participants, but also traffic participants newly entering the visually recognized area (region AR1) as visually recognized. Moreover, in the above-described example, when a predetermined time has elapsed after the area AR1 was set as a visually recognized area, the setting of the visually recognized area may be cancelled.

The embodiment described above can be represented as follows.

A driving assistance device including:
a storage medium storing computer-readable instructions; and
a processor connected to the storage medium, the processor executing the computer-readable instructions for a computer to:
recognize a surrounding situation of a vehicle;
estimate a sight line direction of a driver of the vehicle;
determine whether or not the driver has visually recognized a traffic participant near the vehicle recognized on the basis of the sight line direction; and
determine that the driver has also visually recognized another traffic participant located within a predetermined distance from a traffic participant determined to have been visually recognized by the driver among the traffic participants.

Although modes for carrying out the present invention have been described using embodiments, the present invention is not limited to the embodiments and various modifications and substitutions can also be made without departing from the scope and spirit of the present invention.

### REFERENCE SIGNS LIST

1 Vehicle system
10 Camera
12 Radar device
14 LIDAR
15 Sonar
16 Physical object recognition device
20 Communication device
30 HMI
32 Display
34 Speaker
40 Vehicle sensor
50 Driver monitor camera
80 Driving operation elements
100 Driving assistance device
110 Recognizer
120 Estimator
130 Predictor
140 Determiner
150 Driving controller
160 HMI controller
180 Storage
M Vehicle

What is claim is:

1-8. (canceled)

9. A driving assistance device comprising:
a recognizer configured to recognize a surrounding situation of a vehicle;
an estimator configured to estimate a sight line direction of a driver of the vehicle; and
a determiner configured to determine whether or not the driver has visually recognized a traffic participant near the vehicle recognized by the recognizer on the basis of the sight line direction,
wherein the determiner determines that the driver has also visually recognized another traffic participant located within a predetermined distance from a traffic participant determined to have been visually recognized by the driver among the traffic participants.

10. The driving assistance device according to claim 9, wherein the predetermined distance is different between a direction extending in the sight line direction of the driver of the vehicle and a direction perpendicular to the sight line direction.

11. The driving assistance device according to claim 10, wherein the predetermined distance becomes longer as a direction from a position of the traffic participant becomes closer to the extending direction and becomes shorter as the direction from the position of the traffic participant becomes closer to the perpendicular direction.

12. The driving assistance device according to claim 9,
wherein the estimator estimates a risk value of the traffic participant, and
wherein, when the other traffic participant is located within the predetermined distance, the determiner determines that the other traffic participant has not been visually recognized if a risk value of the other traffic participant estimated by the estimator is greater than or equal to a threshold value.

13. The driving assistance device according to claim 12, wherein the estimator estimates the risk value in accordance with an amount of movement or an attribute of the traffic participant.

14. The driving assistance device according to claim 9, further comprising a notification unit configured to provide a notification to the driver when there are traffic participants not recognized by the driver.

15. A driving assistance method comprising:
recognizing, by a computer, a surrounding situation of a vehicle;
estimating, by the computer, a sight line direction of a driver of the vehicle;
determining, by the computer, whether or not the driver has visually recognized a traffic participant near the vehicle recognized on the basis of the sight line direction; and
determining, by the computer, that the driver has also visually recognized another traffic participant located within a predetermined distance from a traffic participant determined to have been visually recognized by the driver among the traffic participants.

16. A non-transitory computer-readable storage medium that stores a program to be executed by a computer to perform at least:
recognize a surrounding situation of a vehicle;
estimate a sight line direction of a driver of the vehicle;
determine whether or not the driver has visually recognized a traffic participant near the vehicle recognized on the basis of the sight line direction; and
determine that the driver has also visually recognized another traffic participant located within a predetermined distance from a traffic participant determined to have been visually recognized by the driver among the traffic participants.
